(19) United States
(12) Patent Application Publication
(10) Pub. No.: US 2003/0042195 A1
(43) Pub. Date: Mar. 6, 2003

(54) Multi-ply filter

(76) Inventors: Lois Jean Forde-Kohler, Cincinnati, OH (US); Ward William Ostendorf, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/946,018

(22) Filed: Sep. 4, 2001

(51) Int. Cl. B01D 29/00

(52) U.S. Cl. 210/488

(57) ABSTRACT

A multi-ply filter and a water-purification kit. The filter comprises at least two adjacent plies, wherein at least one of the plies comprises a multi-density fibrous structure having a plurality of discrete pseudo-apertures disposed therein, the pseudo-apertures having individual areas of at least about 3 square millimeters and a basis weight from about 0.1 to about 5 gram per square meter. The kit comprises the multi-ply filter and a water-purification composition comprising a flocculation agent and a coagulation agent.

### FIELD OF THE INVENTION

The present invention is related to disposable filters. More particularly, this invention is concerned with multi-ply disposable filters made from structured fibrous webs.

### BACKGROUND OF THE INVENTION

Disposable paper filters are known in the art. For example, U.S. Pat. No. 5,554,288 issued on Sep. 10, 1996 and U.S. Pat. No. 5,718,827 issued on February 1998, both issued to Rydell et al. and assigned to Little Rapids Corporation of Green Bay, Wis., disclose disposable paper filters suitable for removal of contaminants from fluids such as water or air. The filters media is made from selected pulp types and contain a uniform, homogenous distribution of certain finely-divided absorbents.

Disposable paper filters can be especially advantageous in geographical regions where there is a need for potable water, such as, for example, developing countries, especially their rural areas, where many people either do not have a direct supply of potable water (and may have access only to a non-potable communal water supply, such as a village well) or cannot be guaranteed that the water they receive is potable.

Commonly-assigned U.S. patent application Ser. No. 09/712,464, filed Nov. 14, 2001 in the name of John Tanner, et al., the disclosure of which is incorporated herein by reference, describes a kit for purifying water and a water-purification composition. The water-purification composition, when mixed with water produces partially purified water having solid matter that can be subsequently removed from the water by filtration.

The solid matter typically has two principal types of flock: a so-called “floating” flock and a so-called “sinking” flock. As their respective names suggest, the floating flock is a flock that floats on the surface of the water or is suspended within the water; and the sinking flock is a flock that has sank and is disposed on the bottom of a container having therein the water to be purified. An average particle size of the sinking flock is about 800 microns. With coagulation and flocculation, the sinking flock can reach about 1 centimeter in size. At the same time, an average particle size of the floating flock is significantly smaller—up to about 1 millimeter. When the water is poured into the filter, the flock particles (especially, the floating flock) can shear thereby becoming smaller than when contained in water. Therefore, it would be highly desirable to create a disposable filter that would remove all kinds of flock contained in water and at the same time have good filtration flow rate characteristics.

Now, it has been discovered that a multi-region fibrous structures, such as, for example, those produced by the current assignee, can deliver excellent results if utilized as a filter medium, especially when those fibrous structures are provided with a plurality of pseudo-apertures therein. More specifically, it has been discovered that a multi-basis weight and/or multi-density fibrous structures having pseudo-apertured regions that are capable of ensuring an acceptable filtration flow rate and yet sufficiently retain solid matter contained in water, can be successfully used a medium for a disposable filter.

Through-air-dried fibrous structures, such as, for example, paper webs, and equipment for making same, are described in several commonly assigned U.S. patents, the disclosures of which are incorporated herein by reference: U.S. Pat. Nos. 4,514,345, issued Apr. 30, 1985 to Johnson et al.; 4,528,239, issued Jul. 9, 1985 to Trokhan; 4,529,480 issued Jul. 16, 1985 to Trokhan; 4,637,859 issued Jan. 20, 1987 to Trokhan; 5,098,522, issued Mar. 24, 1992 to Smurkoski, et al.; 5,245,025 issued Sep. 14, 1993 to Trokhan et al.; 5,260,171, issued Nov. 9, 1993 to Smurkoski et al.; 5,275,700, issued Jan. 4, 1994 to Trokhan; 5,328,565, issued Jul. 12, 1994 to Rasch et al.; 5,334,289, issued Aug. 2, 1994 to Trokhan et al.; 5,431,786, issued Jul. 11, 1995 to Rasch et al.; 5,496,624, issued Mar. 5, 1996 to Stelljes, Jr. et al.; 5,500,277, issued Mar. 19, 1996 to Trokhan et al.; 5,514,523, issued May 7, 1996 to Trokhan et al.; 5,527,428 issued Jun. 18, 1996 to Trokhan et al.; 5,554,467, issued Sep. 10, 1996, to Trokhan et al.; 5,566,724, issued Oct. 22, 1996 to Trokhan et al.; 5,624,790, issued Apr. 29, 1997 to Trokhan et al.; 5,628,876 issued May 13, 1997 to Ayers et al.; 5,679,222 issued Oct. 21, 1997 to Rasch et al.; 5,714,041 issued Feb. 3, 1998 to Ayers et al.; 5,900,122 issued May 4, 1999 to Huston; and 5,948,210 issued Sep. 7, 1999 to Huston.

In papermaking belts of prior art a framework that may be continuous, semi-continuous, comprise a plurality of discrete protuberances, or any combination thereof, is joined to a fluid-permeable reinforcing element (such as, for example, a woven structure, or a felt). The framework extends outwardly from the reinforcing element to form a web-side of the belt (i.e., the surface upon which the web is disposed during a papermaking process), a backside opposite to the web-side, and deflection conduits extending therebetween. The deflection conduits provide spaces into which papermaking fibers deflect under application of a pressure differential during a papermaking process.

Papers produced on such belts are generally characterized by having at least two regions having differential intensive properties, most typically density and/or basis weight. For example, papers made using the belts having a continuous framework and a plurality of discrete deflection conduits dispersed therethrough comprise a continuous high-density network region and a plurality of discrete low-density pillows (or domes), dispersed throughout, separated by, and extending from the network region. The continuous high-density network region is designed primarily to provide strength, while the plurality of the low-density pillows is designed primarily to provide softness and absorbency. Such belts have been used to produce commercially successful products, such as, for example, Bounty® paper towels, Charmin® toilet tissue, and Charmin Ultra® toilet tissue, all produced and sold by the instant assignee.

The present invention provides a novel multi-ply filter comprising a plurality of plies, wherein at least one of the plies comprises a multi-density fibrous structure having a plurality of discrete pseudo-apertures therein. The present invention further provides a process of making such a multi-ply filter. The present invention also provides a water purification kit comprising the multi-ply filter of the present invention and a water-purification composition comprising a flocculation agent and a coagulation agent; and a process for obtaining purified water using the multi-ply filter of the present invention.

### SUMMARY OF THE INVENTION

A multi-ply filter of the present invention comprises at least two adjacent plies. At least one of the plies comprises a multi-density fibrous structure having a plurality of discrete pseudo-apertures disposed therein. The pseudo-apertures can be disposed in a non-random and repeating pattern. The pseudo-apertures have individual areas of about 3 square millimeters or greater and a basis weight from about 0.1 to about 5 gram per square meter. Typically, the individual areas of the pseudo-apertures are from about 3 square millimeters to about 30 square millimeters. At least one of the plies has from about 5,000 to about 90,000, and more specifically from about 9,000 to 35,000 pseudo-apertures per square meter. In some embodiments, the individual areas of the pseudo-apertures have a major axis and a minor axis perpendicular to the major axis, wherein the major axis is from about 1 to about 100, and more specifically from about 5 to about 50 times greater than the minor axis. One of the adjacent plies, a bottom ply, typically does not have pseudo-apertures therein.

Each of the bottom ply and pseudo-apertured plies can comprise a substantially continuous network region and a plurality of discrete fibrous pillows outwardly extending from the network region, wherein a density of the network region is greater than a density of the fibrous pillows. The individual areas of the pseudo-apertures are at least 10 times, more specifically at least 50 times, and even more specifically at least 100 times, larger than individual areas of the fibrous pillows of the bottom ply and/or individual areas of the fibrous pillows of the pseudo-apertured plies (if the fibrous pillows of the pseudo-apertured plies are discrete).

A plurality of mutually adjacent pseudo-apertured plies comprises at least a first pseudo-apertured ply and a second pseudo-apertured ply and can comprise three, four, etc., pseudo-apertured plies. The plurality of mutually adjacent pseudo-apertured plies is disposed adjacent to the bottom ply. In one embodiment, the pseudo-apertures of one ply in the plurality are offset relative to the pseudo-apertures of another ply, for example, the ply adjacent thereto. In a formed filter, the plies are consecutively stacked from the bottom ply to a top ply, the bottom and top plies being on the outside. The size of the individual pseudo-apertures of the plies can increase from the ply adjacent to the bottom ply to the top ply.

At least one of the pseudo-apertured plies can comprise a fibrous structure having relatively high-density regions, relatively low-density regions, and intermediate-density regions. The relatively low-density regions can comprise the plurality of discrete pseudo-apertures. One, several, or all of the pseudo-apertured plies can be foreshortened, by creping or/and wet-microcontraction.

The pseudo-apertured plies can be disposed relative to one another and relative to the bottom ply, depending on the orientation of their respective fibrous pillows. In one embodiment, the pseudo-apertured plies are disposed such that the plurality of fibrous pillows of at least one of the pseudo-apertured plies faces the bottom ply. The plurality of fibrous pillows of the bottom ply can be oriented “downwardly,” or away from the rest of the plies.

A process for making the multi-ply filter of the present invention comprises the steps of (a) providing a bottom ply comprising a substantially continuous network region, and a plurality of fibrous pillows outwardly extending from the network region, wherein a density of the substantially continuous network region is greater than a density of the fibrous pillows; (b) providing a plurality of pseudo-apertured plies, wherein each of the pseudo-apertured plies comprises a fibrous structure having a plurality of discrete pseudo-apertures therein; and (c) superimposing the bottom ply with the plurality of pseudo-apertured plies such that the pseudo-apertured plies are consecutively disposed in a contacting face-to-face relationship to one another.

A water-purification kit of the present invention comprises the multi-ply filter of the present invention and a water-purification composition comprising at least a flocculent and a coagulant, and optionally a disinfecting agent, for simultaneous or sequential use in water purification. In one embodiment, the water-purification composition comprises a primary coagulant selected from the group consisting of water-soluble, multivalent inorganic salts and mixtures thereof; a bridging flocculant selected from the group consisting of water-soluble and water-dispersible anionic and nonionic polymers having a weight average molecular weight of at least about 2,000,000, and mixtures thereof; and a coagulant aid selected from the group consisting of water-soluble and water-dispersible cationic polymers having a weight average molecular weight of less than about 1,500,000, and mixtures thereof. Optionally, the water-purification composition can include disinfectant and/or nutrients.

The present invention also provides a process for obtaining a purified water, the process comprising the steps of: (a) providing the multi-ply filter of the present invention; (b) providing the water-purification composition; and (c) instructing a user to contact an unpurified water with the water-purification composition, thereby obtaining a partially purified water containing solid matter, and to pour the partially purified water through the multi-ply filter to at least partially remove the solid matter, whereby obtaining the purified water.

By using the process of the present invention for obtaining a purified water, one can purify unpurified water (having a turbidity greater than 5 nephelometric turbidity units) to obtain a purified water having a turbidity less than 5, more specifically less than 2, and even more specifically less than 1 nephelometric turbidity units, at a filtration flow rate of at least about 2 liters per minute, using the filter of the present invention. An effective surface area of the filter can conveniently be from 0.1 to 1.0 square meters.

### BRIEF DESCRIPTION OF DRAWINGS

FIGS. 1-4 are schematic plan views of various embodiments of a multi-ply filter of the present invention, comprising four plies, wherein three adjacent plies have pseudo-apertures of various shapes, disposed therein in non-random and repeating patterns. The shapes of the pseudo-apertures and the patterns shown are intended as non-limiting examples.

FIG. 5 is a schematic plan view of an embodiment of a single-ply fibrous structure of the present invention, comprising an integrated pattern formed by two patterns: (i) a first pattern, or micro-pattern, formed by a plurality of discrete intermediate-density regions and (ii) a second pattern, or macro-pattern, formed by a plurality of pseudo-apertures comprising relatively low-density regions.

FIG. 6 is a schematic plan view of another embodiment of a single-ply fibrous structure of the present invention, comprising an integrated pattern formed by two patterns: (i) a first pattern, or micro-pattern, formed by a plurality of substantially semi-continuous intermediate-density regions and (ii) a second pattern, or macro-pattern, formed by a plurality of pseudo-apertures comprising relatively low-density regions.

FIGS. 7-9 are schematic and partial cross-sectional views of various embodiments of the multiply filter of the present invention, wherein each of the plies comprises a multi-density fibrous structure comprising a plurality of fibrous pillows, the figures showing various, non-limiting, orientations of pluralities of fibrous pillows.

FIG. 10 is a schematic and partial plan view of an embodiment of a molding member that can be used in making the fibrous structure of the present invention, the molding member comprising a reinforcing element and a substantially continuous framework joined thereto, the framework having a plurality of discrete deflection conduits extending therethrough in a non-random and repeating macro-pattern.

FIG. 10A is a schematic cross-sectional view of the molding member shown in FIG. 10 and taken along lines 10A-10A.

FIG. 11 is a schematic plan view of another embodiment of a molding member similar to that shown in FIG. 10, the molding member comprising a reinforcing element and a substantially continuous framework joined thereto, the framework having a first non-random and repeating micro-pattern of a first plurality of discrete deflection conduits extending through the framework, and a second non-random and repeating macro-pattern of a second plurality of discrete deflection conduits extending through the framework.

FIG. 11A is a schematic cross-sectional view of the molding member shown in FIG. 11 and taken along lines 11A-11A.

FIG. 12 is a schematic plan view of an embodiment of a forming member that can be used in making the fibrous structure of the present invention, the forming member comprising a reinforcing element and a plurality of discrete protuberances joined thereto and outwardly extending therefrom to form a non-random and repeating macro-pattern.

FIG. 12A is a schematic cross-sectional view of the forming member shown in FIG. 12 and taken along lines 12A-12A.

FIG. 13 is a schematic cross-sectional view of a continuous process for making the fibrous structure of the present invention.

FIGS. 14A-14C show a process for obtaining a purified water according to the present invention.

### DETAILED DESCRIPTION OF THE INVENTION

As used herein, unless otherwise indicated, the following terms have the following meanings.

Basis weight (BW) is the weight (in grams) per unit area (in square meters) of a sample.

Machine direction (MD) is a direction parallel to the flow of the fibrous structure being made during a manufacturing process, at a particular point thereof. Since the direction of the flow of the fibrous structure can (and most typically does) change during the manufacturing process, the machine direction can also change, depending on a particular point of the process under consideration. Cross-machine direction (CD) is a direction perpendicular to the machine direction and parallel to the general plane of the fibrous structure during the manufacturing process at a particular point thereof.

Fibrous structure is an arrangement comprising cellulosic fibers, synthetic fibers, or any combination thereof that form a thin and macroscopically planar sheet.

Pseudo-aperture is a substantially open and low-opacity (to the point of being almost transparent) element of the fibrous structure of the present invention that may appear to be a hole yet has a minimal number of fibers therewithin. The pseudo-apertures have individual open areas of about 3 square millimeters and greater and a very low basis weight from about 0.1 to about 5.0 gram per square meter. The individual areas of the pseudo-apertures can be measured when the pseudo-apertured fibrous structure is placed in a two-dimensional configuration on an X-Y reference plane. The symbols “X-Y” and “Z” designate a conventional three-dimensional Cartesian coordinate system, with X-Y forming the reference plane, and Z being perpendicular to the X-Y plane. The individual areas of the pseudo-apertures can also be approximated based on the relevant elements (such as, for example, the size and shape of deflection conduits and/or protuberances that form the pseudo-apertures) of a molding member and or a forming member used to make the pseudo-apertured fibrous structure, as explained below. The real size of the pseudo-apertures, however, may be different from those of the deflection conduits of the molding member and the protuberances of the forming member, especially if the fibrous structure has been forshortened. The pseudo-apertures have a high fluid permeability that allows fluids, such as water, to easily pass therethrough, while at the same time are capable of retaining at least some particles comprising solid matter, such as contaminants contained in water, due to a shape of the pseudo-apertures and the existence of fibers within the pseudo-apertures. A pattern of a plurality of pseudo-apertures is referred herein to as a “second pattern” and/or as a “macro-pattern.” A pseudo-apertured ply (or web, or fibrous structure, or sheet) is a fibrous structure that has a plurality of pseudo-apertures therein.

The pseudo-apertures of one ply are said to be “offset” relative to the pseudo-apertures of another ply (for example, an adjacent ply) when orthogonal (Z) individual projection areas of the pseudo-apertures of the one ply to the X-Y reference plane and orthogonal (Z) individual projection areas of the pseudo-apertures of the other ply to the same X-Y reference plane form a common individual areas that are less than about 50% of the smallest one of these individual projections. For example, if the individual areas (and thus their orthogonal projections) of the pseudo-apertures of one ply are 12 square millimeters; and the individual areas (and thus their orthogonal projections) of the pseudo-apertures of the other ply are 6 square millimeters, the pseudo-apertures of these two plies will be considered “offset” if common individual areas formed by orthogonal projections of both of these plies' pseudo-apertures to the reference X-Y reference plane are less than about 3 square millimeters (i.e., less than about half of the smallest, 6-square-millimeter, individual areas of the pseudo-apertures of one of the plies under consideration).

Effective surface area (of a filter) is a surface of the filter's top ply that is contacted by water being purified during a process of water purification.

Turbidity is a quality, or state, of water having particles of solid matter therein in a floating, suspended, or sinking state. Turbidity is measured in nephelometric turbidity units (NTU)—according to Method 180.1, entitled “Determination of Turbidity by Nephelometry” (Revision 2.0, August 1993) of Environmental Monitoring Systems Laboratory, Office of Research and Development, U.S. Environmental Protection Agency, Cincinnati, Ohio 45268, which method is incorporated herein by reference and attached herein as Appendix.

Filtration flow rate is a volume of water (liters) being filtered within a specified unit of time (minute) through the filter of the present invention.

“Macroscopical” or “macroscopically” refers to an overall geometry of a structure under consideration (a web, a molding member, or a forming member) when it is placed in a two-dimensional configuration on the X-Y reference plane. In contrast, “microscopical” or “microscopically” refers to relatively small details of the structure under consideration, without regard to its overall geometry.

“Substantially continuous” element (framework, region, area, surface, etc.) refers to an element (of a molding member or the fibrous structure of the present invention) wherein one can connect any two points on or within the element by an uninterrupted line running entirely on or within that substantially continuous element throughout the line's length. For example, the continuous framework of the molding member has a substantial “continuity” in all directions parallel to the reference X-Y plane and is terminated only at edges of the molding member. The term “substantially” (in conjunction with continuous) means that while an absolute continuity of the element under discussion is preferred (and intended while designing and making the element), minor deviations from the absolute continuity may be tolerable as long as those deviations do not appreciably affect the performance of the element or a member comprising such element, as designed and intended.

“Substantially semi-continuous” element (framework, region, area, surface, etc.) refers to an element which has “continuity” in all, but at least one, directions parallel to the X-Y plane, and in which element one cannot connect any two points on or within the element by an uninterrupted line running entirely on or within that element throughout the line's length. The semi-continuous element may have continuity only in one direction parallel to the X-Y plane, or in any number of directions but one direction parallel to the X-Y plane. By analogy with the continuous pattern described above, while an absolute continuity in all, but at least one, directions is preferred, minor deviations from such continuity may be tolerable as long as those deviations do not appreciably affect the performance of the element under consideration.

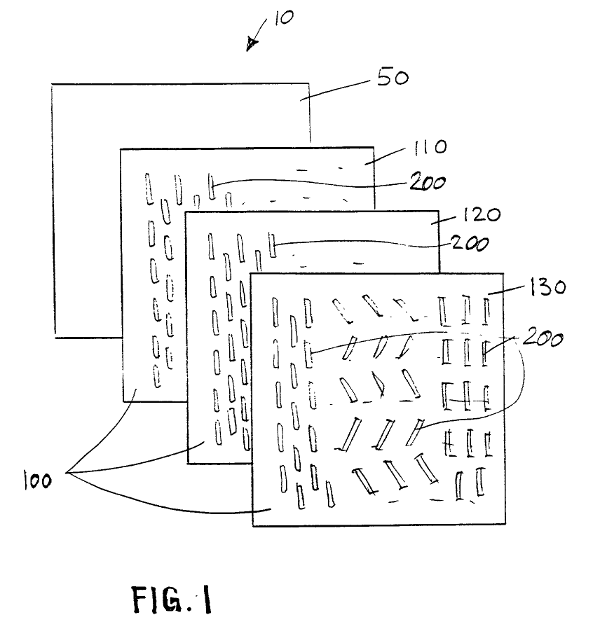

Referring to FIGS. 1-4, a multi-ply filter of the present invention 10 comprises at least two adjacent plies 100. At least one of the plies 100 comprises a fibrous structure having a plurality of discrete pseudo-apertures 200. In the embodiments shown in FIGS. 1-4, the filter 100 comprises four plies, three of which are pseudo-apertured plies: a first pseudo-apertured ply 110, a second pseudo-apertured ply 120, and a third pseudo-apertured ply 130. A bottom ply 50 does not have pseudo-apertures 200 therein.

The pseudo-apertures 200 can be disposed in the fibrous structure 100 in a generally nonrandom and repeating pattern. The pattern may vary from one pseudo-apertured ply to another, and even within one pseudo-apertured ply. For example, one portion of the pseudo-apertured ply may have a pattern that is different from that of the other portion of the same pseudo-apertured ply. There can be from about 5,000 to about 90,000, and more specifically from about 9,000 to about 35,000 pseudo-apertures 200 per square meter in each of the pseudo-apertured plies 100.

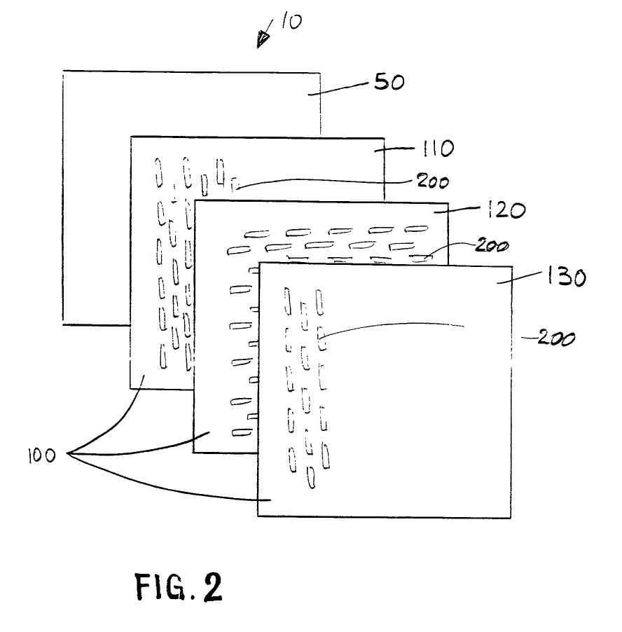

The individual areas of the pseudo-apertures 200 can have a major axis 201 and a minor axis 202 perpendicular to the major axis 201 (FIG. 5). The major axis 201 is from about 1 times to about 100 times, and more specifically from about 5 times to about 50 times, greater than the minor axis 202. Such a configuration is believed to facilitate retention of a solid matter contained in water and at the same time provide a sufficient fluid permeability of the ply. The major axis can be oriented in the machine direction, the cross-machine direction, or any other direction.

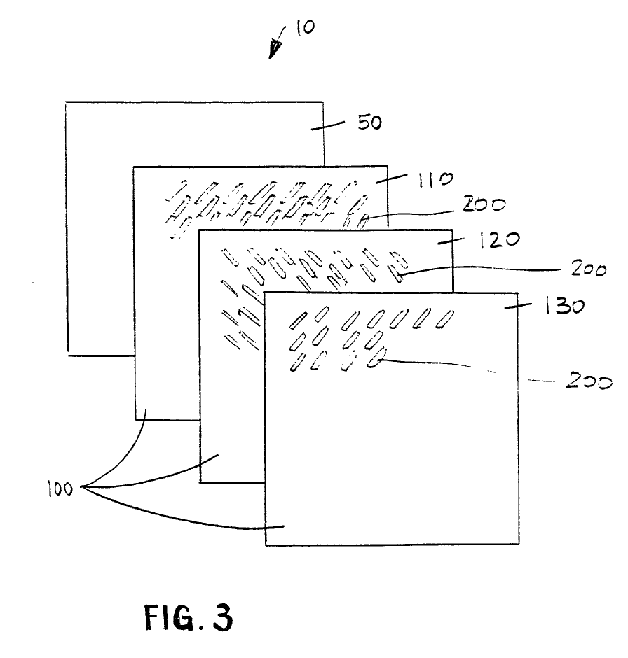

FIGS. 5-9 show an embodiment of the multi-ply filter 10 in which the plies 100 comprise a multi-density fibrous structure. In the embodiment of FIG. 5, the multi-density fibrous structure (designated, as an example, as the first ply 110) comprises a substantially continuous network region 112 and a plurality of fibrous pillows 114 outwardly extending from the network region 112. A density of the network region 112 being greater than a density of the fibrous pillows 114. In FIG. 6, the multi-density fibrous structure (designated, as an example, as the second ply 120) comprises a substantially semi-continuous network region 122 and a plurality of substantially semi-continuous fibrous pillows 124 outwardly extending from the network region 122, a density of the network region 122 being greater than a density of the fibrous pillows 124.

The bottom ply 50 is a ply that typically has no pseudo-apertures therein and is intended to support the plurality of pseudo-apertured plies 100 during the use of the filter 10. The bottom ply 50 can also be made of a multi-density fibrous structure described herein. Overall, the filter 10 may comprise from 2 to N plies, wherein the number of the pseudo-apertured plies can be from 1 to N−1, wherein N is an integer. The individual plies 100 are sequentially stacked on top of one another, from a first pseudo-apertured ply adjacent to the bottom ply 50 to a top ply, with the top and bottom plies being outside plies. It is to be understood that while the embodiment of the filter 10 in which each of at least three pseudo-apertured plies 100 comprises the multi-density structure proved to be the most efficient, the filter 10 may comprise a different number of multi-density pseudo-apertured plies, for example, 1, 2, 4, etc.

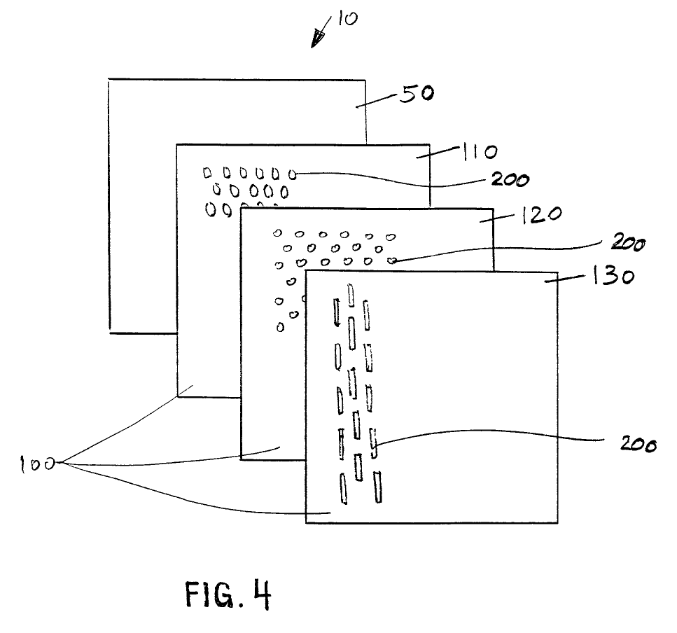

The embodiments depicted in FIGS. 7-9 show non-limiting examples of various orientations of pluralities of fibrous pillows of the pseudo-apertured plies 100 relative to one another ant to the bottom ply 50. FIG. 7 shows a four-ply filter 10, wherein the three pseudo-apertured plies 110, 120, and 130 are disposed such that the plurality of fibrous pillows 114 of the first pseudo-apertured ply 110 and the plurality of fibrous pillows 134 of the third pseudo-apertured ply 130 face the bottom ply 50, while the plurality of fibrous pillows 124 of the second pseudo-apertured ply 120 faces away from the bottom ply 50. In FIG. 8, the plurality of fibrous pillows 114 of the first pseudo-apertured ply 110 face away from the bottom ply 50, while the plurality of fibrous pillows 124 of the second pseudo-apertured ply 120 and the plurality of fibrous pillows 134 of the third pseudo-apertured ply 130 face the bottom ply 50. FIG. 9 shows a three-ply filter 10, wherein the plurality of fibrous pillows 114 of the first pseudo-apertured ply 110 faces the bottom ply 50, while the plurality of fibrous pillows 124 of the second pseudo-apertured ply faces away from the bottom ply 50. The plurality of fibrous pillows 54 of the bottom ply 50 can face away from the pseudo-apertured plies (FIGS. 7 and 8) or can face the pseudo-apertured plies (FIG. 9).

It is believed that placing at least some of the pseudo apertured plies 100 in the filter 10 so that their fibrous pillows are oriented “downwardly” routs maximum amount of water being poured through the filter (and thus more flock particles contained therein) towards less dense, i.e., more “open” fibrous pillows. This maximizes a filtration flow rate, which is an important factor to be considered in designing pour-through filters. In a conventional home-use device, described below, the filtration flow rate of about 2 liters per minute or greater is desirable.

The individual areas of the pseudo-apertures 200 can be at least 10 times, more specifically at least 50 times, and even more specifically at least 100 times, larger than individual areas of the fibrous pillows 54 of the bottom ply 50 and/or individual areas of the fibrous pillows 114, 124, 134 of the pseudo-apertured plies 110, 120, 130, respectively. Typically, the individual areas of the pseudo-apertures are from about 3 square millimeters to about 30 square millimeters.

The pseudo-apertures 200 of one pseudo-apertured ply can be offset relative to the pseudo-apertures 200 of another pseudo-apertured ply. This arrangement is believed to be beneficial to the solid mater retaining capabilities of the filter 10 of the present invention. For example, the pseudo-apertures 200 of the first pseudo-apertured ply 110 can be offset relative to the pseudo-apertures 200 of the second pseudo-apertured ply 120 adjacent to the first pseudo-apertured ply 110. Or, additionally or alternatively, the pseudo-apertures 200 of the first pseudo-apertured ply 110 can be offset relative to the pseudo-apertures 200 of the third pseudo-apertured ply 130.

In the multi-ply paper filter 10 of the present invention, it may be beneficial to provide that the individual areas of the pseudo-apertures 200 in the pseudo-apertured plies increase from the ply adjacent to the bottom ply (the first ply 110 in FIGS. 7-9) to the top ply (the third ply 130 in FIGS. 7 and 8, and the second ply in FIG. 9). Such an arrangement is believed to facilitate a staged filtration, which takes place when water being poured through the filter passes through multiple plies.

The pseudo-apertured fibrous structure 100 can have three differential-density or/and basis weight regions. The disclosure of commonly assigned U.S. Pat. No. 5,277,761 (Dean Van Phan et. al, issued January 1994) is incorporated herein by reference. This patent describes a cellulosic fibrous structure, such as paper, that has at least three distinct regions. The regions are distinguished from one another by intensive properties, such as basis weight, density, projected average pore size, and thickness. All of these permutations are contemplated in the pseudo-apertured fibrous structure 100 of the present invention.

The pseudo-apertured fibrous structure 100 of the present invention can be viewed as a fibrous structure having relatively high-density regions, relatively low-density regions comprising pseudo-apertures 200, and intermediate-density regions. The relatively high-density regions can comprise a substantially continuous network region (112, 122, 132), and the intermediate-density regions can comprise a plurality of discrete fibrous pillows (114, 124, 134) extending outwardly from the network region. A density of the pseudo-apertures 200 can range from about 1 gram per cubic meter to about 20 gram per cubic meter, and more specifically, from about 3 gram per cubic meter to about 10 gram per cubic meter.

Methods of measuring a basis weight and a density of differential regions of fibrous structures are described in detail in the above-referenced commonly-assigned and incorporated herein by reference U.S. Pat. No. 5,277,761, starting at column 15, line 25, under the heading “Analytical Procedures.” Those methods can be applied to measuring the basis weight and the density of the differential regions of the pseudo-apertured plies 100 of the present invention, including the pseudo-apertures 200.

A process for making a multi-ply paper filter 10 of the present invention comprises, in essence, the steps of providing the bottom ply 50 and a plurality of the pseudo-apertured plies 100, as described herein, and superimposing the bottom ply 50 with the plurality of pseudo-apertured plies 100 such that the pseudo-apertured plies 100 are consecutively disposed in a contacting face-to-face relation to one another. The process for making the filter 10 can include additional steps of securing the plurality of the pseudo-apertured plies 100 to one another and/or to the bottom ply 50, configuring the individual plies to a desired shape, before or/and after the step of superimposing the bottom ply with the plurality of pseudo-apertured plies.

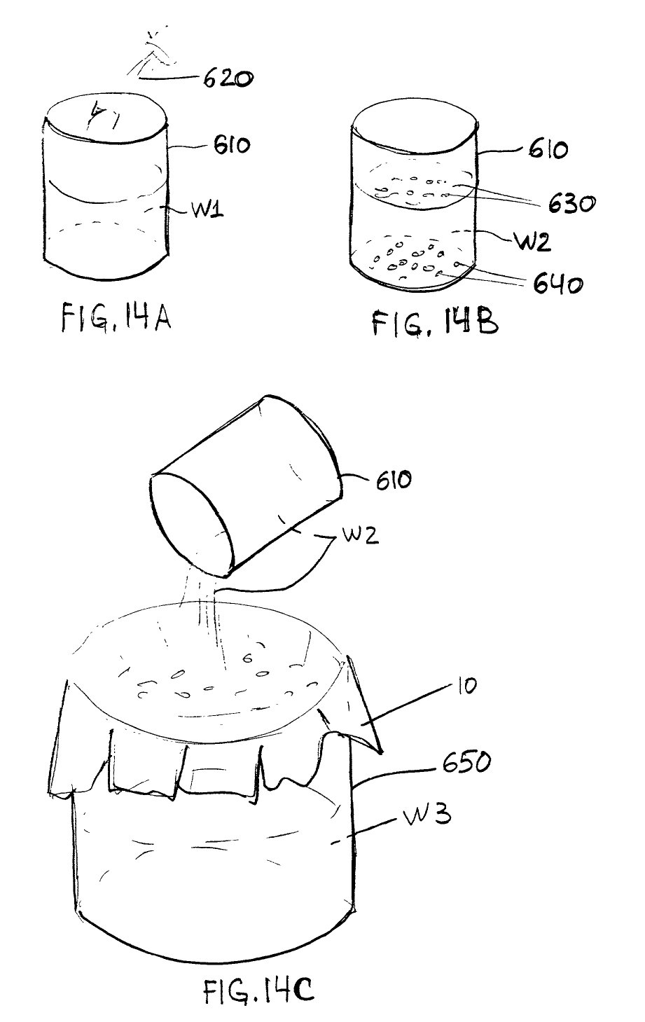

FIGS. 14A-14C show a water-purification kit that includes the filter 10, and a process for obtaining purified water W3 from unpurified water W1 using the filter 10, according to the present invention. The unpurified water W1 could have a turbidity of greater than 5 nephelometric turbidity units, and even greater than 10 nephelometric turbidity units. It is desirable to purify the water to a turbidity of less than about 5, more specifically less than 2, and still more specifically less than 1 nephelometric turbidity units, while maintaining an acceptable filtration flow rate.

A water-purification kit of the present invention comprises the multi-ply paper filter 10 of the present invention and a water-purification composition 620 comprising at least one of flocculation agent and a coagulation agent. More specifically, the water-purification composition 620 can comprise a primary coagulant, a bridging flocculant and a coagulant aid. The primary coagulant can be selected from the group consisting of water-soluble, multivalent inorganic salts and mixtures thereof, such as, for example, iron sulphate, iron chloride, aluminium chloride, aluminium sulphate, manganese sulphate, manganese chloride, copper sulphate, copper chloride, poly-variations thereof, and mixtures thereof. Generally, such water-purification composition 620 can comprise from about 10% to about 99%, more specifically from about 15% to about 50%, and even more specifically from about 25% to about 40% by weight of the primary coagulant. The bridging flocculant can comprise a high molecular weight water-soluble or water-dispersible polymer or mixture of polymers having a weight average molecular weight of at least about 2,000,000, more specifically at least about 5,000,000 and even more specifically at least about 15,000,000. Bridging flocculants can be selected from the group consisting of water-soluble and water-dispersible anionic and nonionic polymers and mixtures thereof, generally comprising from about 0.1% to about 10%, more specifically from about 0.2% to about 5%, and even more specifically from about 0.5% to about 3% by weight of the bridging flocculent.

The term ‘coagulant aid’ herein refers to a water-soluble or water-dispersible polymer of lower molecular weight than that of the bridging flocculent and which aids the overall aggregation and flocculation process. The coagulant aid can comprise a low molecular weight, water-soluble or water-dispersible polymer which generally has a weight average molecular weight of less than about 1,500,000, more specifically less than about 750,000 and even more specifically less than about 300,000, and mixtures thereof. Generally the water-purification composition 620 herein comprises from about 0.1% to about 10%, more specifically from about 0.5% to about 5%, an more specifically from about 1% to about 4% by weight of the coagulant aid.

Generally, the coagulation agent brings together tiny material particles contained in water. The flocculation agent creates larger suspended, floating, or sinking flocks in the water. A disinfectant can then be released into the water, but more specifically into the region where the flocks are concentrated. This kills bacteria and viruses. The flocks are also important for collection of cysts. Typically, these thick-walled microbes are not killed by disinfectant release but can be removed in the filtration process because they can be included in the flocks.

The weight ratio of primary coagulant to bridging flocculant is from about 10:1 to about 200:1, more specifically from about 15:1 to about 150:1, more specifically from about 20:1 to about 100:1, and even more specifically from about 25:1 to about 75:1. A primary coagulant can be selected from the group consisting of water-soluble multivalent inorganic salts and mixtures thereof; a water-soluble or water-dispersible polymeric bridging flocculant wherein the weight ratio of primary coagulant to bridging flocculant is from about 10:1 to about 150:1, more specifically from about 20:1 to about 100:1, and even more specifically from about 25:1 to about 75:1; and optionally a water-soluble or water-dispersible polymeric coagulant aid.

The water-purification composition 620 having optimum purification and clarification performance can also be defined by reference to the weight ratio of the primary coagulant and coagulant aid to the bridging flocculant. The weight ratio of primary coagulant to coagulant aid can be from about 8:1 to about 100:1, more specifically from about 12:1 to about 30:1, and even more specifically from about 15:1 to about 25:1. The weight ratio of coagulant aid to bridging flocculent, on the other hand, can be in the range from about 10:1 to about 1:6, more specifically from about 5:1 to about 1:3, and even more specifically from about 3:1 to about 1:1.

The water-purification composition 620 can also comprise a microbiocidal disinfectant, such as, for example, a chlorine-based disinfectant, and more specifically calcium hypochlorite. The water-purification composition 620 herein can comprise primary coagulant and microbiocidal disinfectant in a weight ratio of from about 10:1 to about 100:1, more specifically from about 12:1 to about 60:1, and even more specifically from about 15:1 to about 40:1. Generally, the water-purification composition 620 herein comprises from about 0.2% to about 10%, more specifically from about 0.5% to about 4%, and even more specifically from about 0.7% to about 2.5% by weight of the microbiocidal disinfectant.

The water-purification composition 620 can also comprise a water-soluble alkali, believed to be valuable from the viewpoint of delivering an optimum in-use pH profile. The levels of primary coagulant and alkali could be adjusted so as to provide a pH at in-use concentration (generally about 620 ppm of total water-purification composition 620) in the range from about 6.0 to 8.5, and more specifically in the range from about 6.0 to 7.0. To achieve the requisite pH levels, the weight ratio of primary coagulant to water-soluble alkali can be in the range from about 0.8:1 to about 3:1, more specifically from about 0.9:1 to about 2.4:1, and even more specifically from about 1:1 to about 2:1. Generally, the water-purification composition 620 comprises from about 10% to about 45%, more specifically from about 15% to about 40%, and even more specifically from about 20% to about 35% by weight of the water-soluble alkali.

The water-purification composition 620 can also include a water-insoluble silicate material such as a clay or zeolite, which acts to aid the flocculation process by acting as a seed particle or by promoting absorption or cation exchange of metal ions. The weight ratio of primary coagulant to water-insoluble silicate herein is from about 0.3:1 to about 5:1, more specifically from about 0.7:1 to about 2:1, and even more specifically from about 0.8:1 to about 1.2:1. Generally, the water-purification composition 620 herein comprises from about 10% to about 80%, more specifically from about 20% to about 50%, and even more specifically from about 25% to about 35% by weight of the water-insoluble silicate.

The filter 10 of the present invention, the water-purification composition 620, and the kit herein can be utilized in a variety of forms and process types, including batch and continuous processes. Specifically, the water-purification composition 620 can be beneficially combined with the filter 10 and the kit of the present invention in a unit dosage form and is used in the batchwise purification and clarification of a relatively small predetermined volume of contaminated drinking water, i.e., a volume of water typically required for immediate consumption in domestic or personal use, or which is required for short term storage and consumption. Typically, the filter 10 and the water-purification composition 620 are designed to be used for treating a volume of contaminated drinking water in the range from about 0.1 to about 100, more specifically from about 0.5 to about 40, more specifically from about 5 to about 20, and even more specifically from about 8 to about 13 liters. Unit dosage amounts of the water-purification composition 620, on the other hand, can generally range from about 50 to about 2000, more specifically from about 100 to about 1000, and even more specifically from about 250 to about 750 mg per liter of contaminated drinking water. Unit dosage forms suitable for use herein include tablets, compacts, extrudates, water-soluble single and multi-compartment pouches etc., but preferred unit dosage forms are single and multi-compartment sachets comprising a unit dose of granular or powdered water-purification composition 620 which can be opened prior to use so that their contents can be emptied into a predetermined quantity of contaminated drinking water (FIG. 14A). An example of the water-purification composition 620 in unit dosage form comprises: from about 15% to about 50%, more specifically from about 25% to about 40%, by weight of the primary coagulant; from about 0.2% to about 5%, more specifically from about 0.5% to about 3%, by weight of the bridging flocculent; and from about 0.5% to about 5%, more specifically from about 1% to about 4%, by weight of the coagulant aid.

It is also important to ensure that effective levels of the formulation ingredients of the water-purification composition 620 are delivered to the sample of contaminated water to be purified. Thus the levels of the primary coagulant, the bridging flocculant and the coagulant aid in water-purification composition 620 should preferably be sufficient to provide by weight of the contaminated drinking water from about 50 to about 500, more specifically from about 75 to about 300, and even more specifically from about 100 to about 250, ppm of primary coagulant; from about 1 to about 15, more specifically from about 2 to about 10, and even more specifically from about 2.5 to about 7.5. ppm of bridging flocculant; and from about 1 to about 25, more specifically from about 5 to about 20, and even more specifically from about 8 to about 12, ppm of coagulant aid.

It could be beneficial if the microbiocidal disinfectant is incorporated in the water-purification composition 620 in a controlled, delayed, sustained or slow release form whereby the disinfectant is released into the drinking water and allowed to react with soluble organic impurities therein only after substantial completion of the coagulation and flocculation stage, this being valuable from the viewpoint of controlling and minimizing the level of trihalomethanes (THM) generated during the purification process. A measure of the rate of release of disinfectant herein is tmax, this being the time taken to achieve maximum residual disinfectant concentration after addition of the water-purification composition 620 to deionized water at 20° C. with gentle stirring. The water-purification composition 620 herein have a tmax of at least about 1 minute, more specifically at least about 2 minutes, and even more specifically at least about 4 minutes, and still more specifically at least about 8 minutes. The rate of coagulation and flocculation of organic impurities, on the other hand, is measured by the n %-ile soluble organic matter flocculation rate (tn). The n %-ile soluble organic matter flocculation rate is defined herein as the time taken for n % reduction in the concentration of humic acid. For the water-purification composition 620 herein t80 is less than about 2 minutes, more specifically less than about 1 minute, and even more specifically less than about 30 seconds. In one embodiment, moreover, t90 for the water-purification composition 620 herein is less than about 2 minutes, more specifically less than about 1 minute, and even more specifically less than about 30 seconds. In another embodiment, the disinfectant and water-purification composition 620 can be used in separate treatment steps, either simultaneously or sequentially with one another.

The water-purification composition 620 and/or the kit of the present invention can also comprise a food additive or a nutrient source necessary for good health and nutrition. The food additive or nutrient source can be included in the kit of the invention as one or more separate water-purification composition 620 in unit dosage form, or they can be incorporated directly into the water-purification composition 620 itself.

As schematically illustrated in FIGS. 14A-14C, the process for obtaining a purified water using the filter 10 of the present invention comprises the steps of providing a multi-ply filter 10; providing the water-purification composition 620 comprising the flocculation agent and the coagulation agent; instructing a user to (i) contact an unpurified water W1 with the water-purification composition 620 (FIG. 14A), thereby obtaining a partially purified water W2 (FIG. 14B) containing solid matter 630, 640 (FIG. 14B) and (ii) pour the partially purified water W2 through the filter 10 to at least partially remove the solid matter 630, 640, whereby obtaining purified water W3.

Of course, one skilled in the art will appreciate that a first conventional container 610 for the unpurified water W1 and a second conventional container 650 for the purified water W3 could be conveniently used in the process and do not need to be provided with the kit. The step of instructing a user can be performed using any conventional means, including, but not limited to, providing a written and/or oral instruction (including, for example, those made over the telephone, or using a computer). It is to be understood that the instruction may be implied—by virtue of selling a user the kit in reliance that the user would know how to use such a relatively simple device for an obviously intended task. The process can further comprise the steps (and the user can also be further instructed to act accordingly) of agitating or stirring the water briefly after adding the water-purification composition 620, and letting the water stand for about 5-10 minutes, after which the water can be stirred or agitated for another 20 minutes or so. During this time the water-insoluble flocks form in the water. Then the water can be purred through the filter 10 to separate water from the insoluble solid matter.

It is believed that the filter 10 of the present invention comprising four plies, three of which are the pseudo-apertured plies 100 having the pseudo-apertures 200 with individual areas from about 3 square millimeters to about 30 square millimeters, wherein the major axis ranges from about 3 mm to about 30 mm, and the minor axis ranges from about 0.5 mm to about 2.5 mm, is capable of removing both the floating flock 630 and the sinking flock 640 to the extent that the purified water W3 had a turbidity of less than 2 nephelometric turbidity units, at the filtration flow rate of greater than about 2 liters per minute. By using the process of the present invention for obtaining a purified water, one can purify unpurified water having a turbidity greater than 5 nephelometric turbidity units to obtain a purified water having a turbidity less than 5, more specifically less than 2, and even more specifically less than 1 nephelometric turbidity units, at a filtration flow rate of at least about 2 liters per minute, using the filter of the present invention. An effective surface area of the filter can conveniently be from 0.1 to 1.0 square meters, and more specifically from 0.2 to 0.8 square meters.

The pseudo-apertured fibrous structure 100 that can be used in the filter 10 of the present invention is described in a commonly assigned and co-pending U.S. patent application Ser. No. ______, filed on the filing date of the present application, and titled “Pseudo-Apertured Fibrous Structure,” the disclosure of which is incorporated herein by reference.

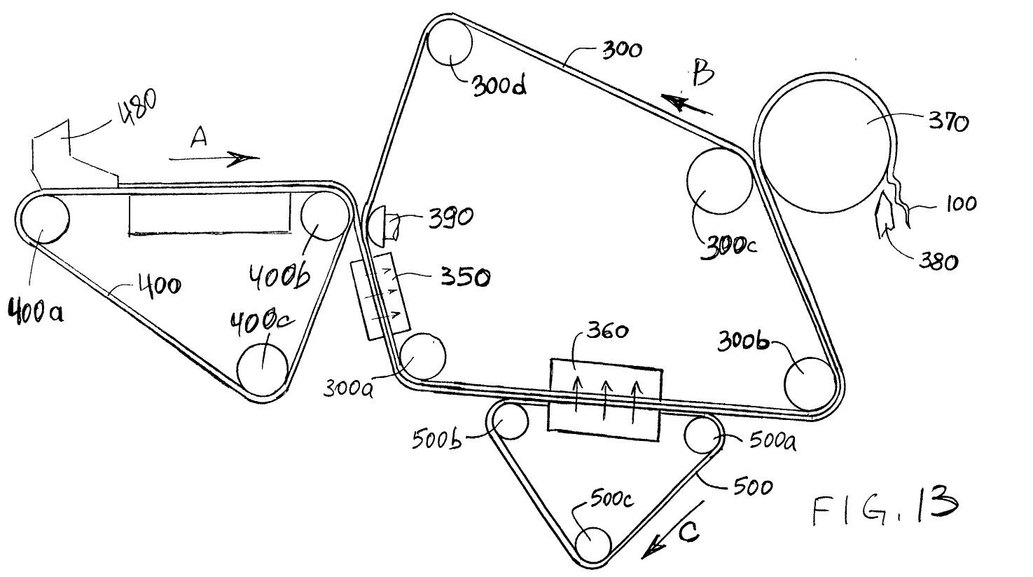

The pseudo-apertured fibrous structure 100 of the present invention can be made by two principally different processes or a combination thereof, FIG. 13. In one process, the pseudo-apertures 200 can be formed prior to and independently from the formation of the fibrous pillows. In another process, the pseudo-apertures 200 can be formed simultaneously with the formation of the fibrous pillows. In the former process the pseudo-apertures 200 can be formed in a forming section of a paper machine, while in a latter process the pseudo-apertures 200 can be formed in a pressing section of the paper machine. One skilled in the art would appreciate that generally, the forming section of the paper machine (FIG. 13) is a section where aqueous dispersion of cellulosic fibers is deposited onto a forming member 400 so that water can be drained therefrom and an embryonic web be formed on the forming member 400. From the forming member 400 the embryonic web is transferred to the molding member 300 of the pressing section where the embryonic web can be pressed against a patterned surface of the molding member 300, to be further dewatered and structured.

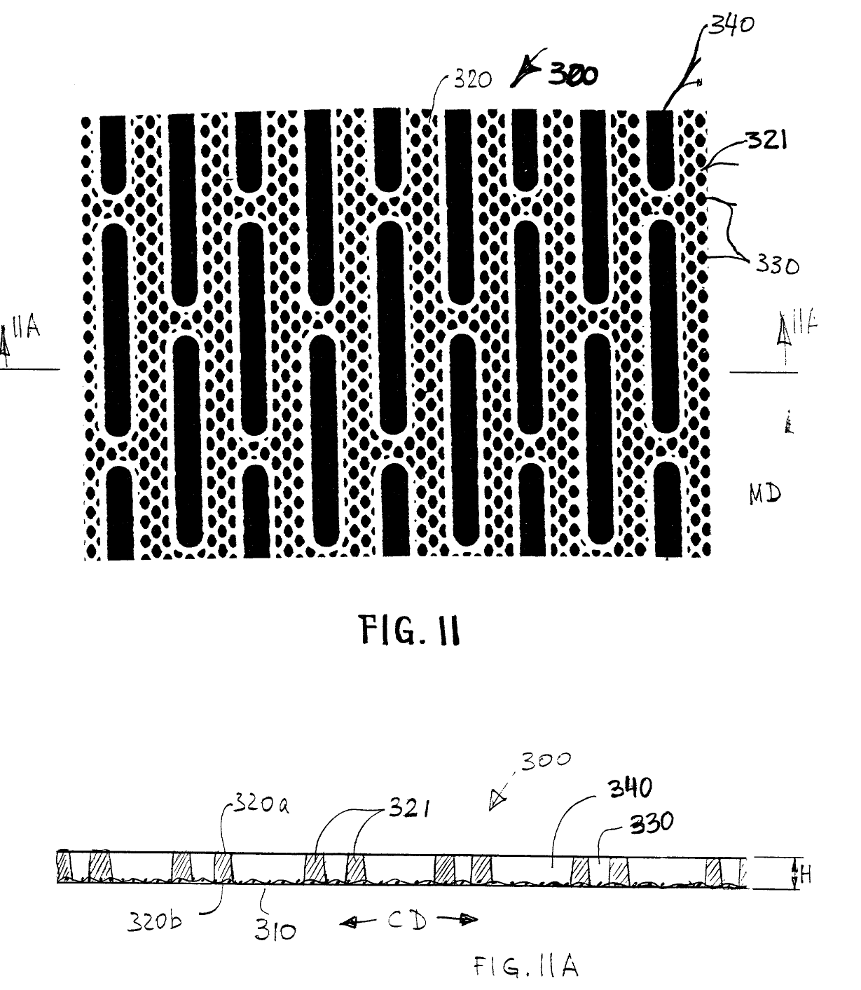

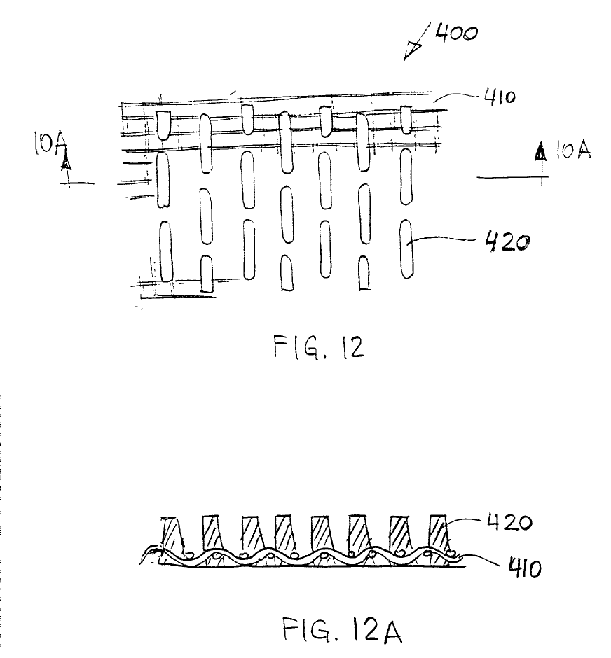

The process wherein the pseudo-apertures 200 are formed in a forming section of a paper machine comprises the following steps: providing a fluid-permeable forming member 400 (FIGS. 12 and 12A) comprising a first reinforcing element 410 and a plurality of protuberances 420 joined thereto and outwardly extending therefrom; providing a plurality of fibers; depositing the plurality of fibers to the forming member 400 thereby forming a fibrous web thereon such that the plurality of discrete protuberances 420 form the plurality of apertures in the web; providing a fluid-permeable molding member 300 comprising a framework 320 having a web-side 320a and comprising a first plurality of deflection conduits 330; transferring the web from the forming member 400 to the molding member 300; applying a fluid pressure differential to the web to (i) deflect selected portions of the web into the first plurality of deflection conduits of the molding member 300, thereby forming a plurality of fibrous pillows therein, and (ii) cause individual fibers disposed at a periphery of the apertures to at least partially extend into the areas of the apertures, thereby forming the pseudo-apertures 200 having the basis weight from about 0.1 to about 5 gram per square meter. The process can further comprise steps of pressing the web disposed on the molding member 300 against a pressing surface, such as, for example, a surface of a Yankee dryer 370, shown in FIG. 13, to densify portions of the web.

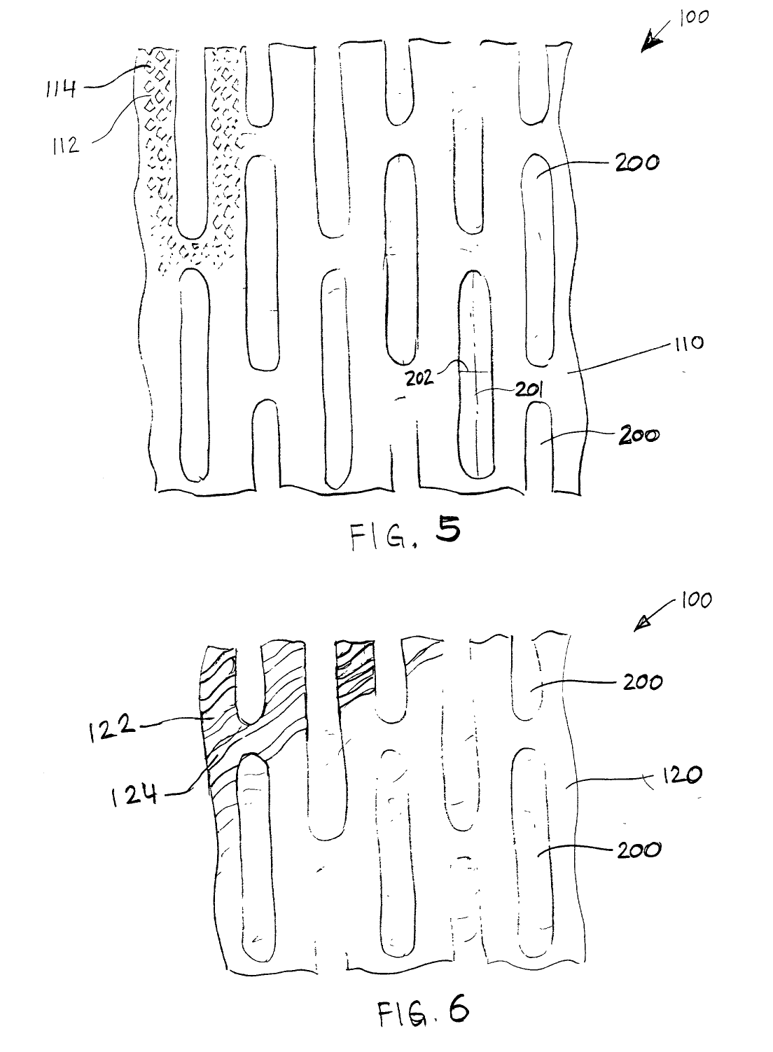

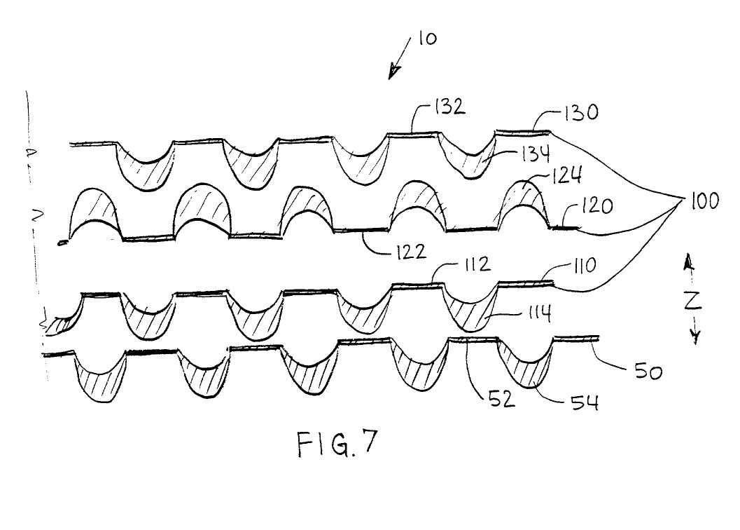

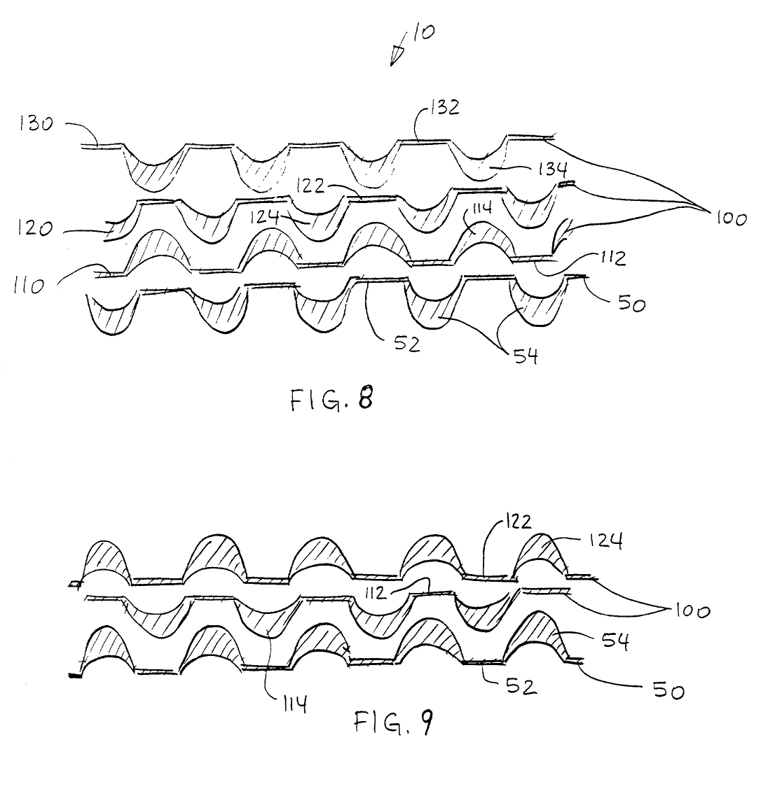

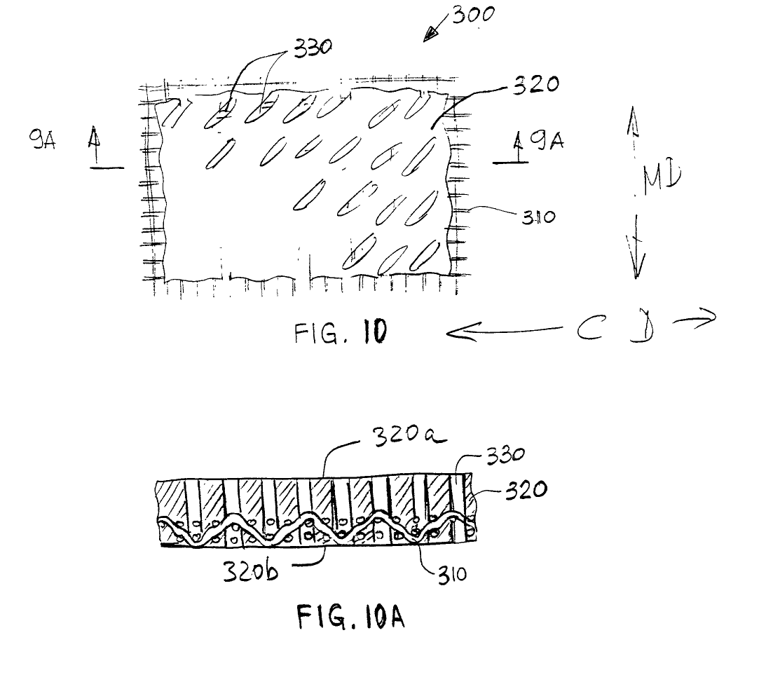

The process wherein the pseudo-apertures 200 are formed in a pressing section of a paper machine comprises, additionally or alternatively to the steps of “forming” section process described in the preceding paragraph, the following steps: providing the fluid-permeable molding member 300 (FIGS. 10-11A) comprising the framework 320, wherein the framework comprises the first plurality of deflection conduits 330 (the “micro-pattern) and a second plurality of deflection conduits 340 (the “macro-pattern”); depositing a plurality of fibers to the web-side 320a of the molding member 300; deflecting a first plurality of fibers into the first plurality of deflection conduits 330 thereby forming a plurality of fibrous pillows therein; and deflecting a second plurality of fibers into the second plurality of deflection conduits 340 thereby forming a plurality of pseudo-apertures 200 in the web.

One skilled in the art will appreciate that both “forming” section and “pressing” section processes described above can be combined such that the pseudo-apertures are formed on both the forming member 400 and the molding member 300.

In the forming member 400, the first reinforcing element 410 is disposed at a first elevation, and the plurality of discrete protuberances 420 extends therefrom to form a second elevation. If desired, the plurality of discrete protuberances 420 can comprise a non-random and repeating pattern. The individual areas of the protuberances 420 at the first elevation are at least about 3 square millimeters. The individual areas of the protuberances 420 at the first elevation can have a major axis and a minor axis perpendicular to the major axis (analogously to the major and minor axes of the pseudo-apertures 200 described above), the major axis being from about 1 to about 100, and more specifically from about 5 to about 50, times greater than the minor axis. The individual areas of the deflection conduits of the first (micro-pattern) plurality are at least 10 times more specifically at least 50 times, and even more specifically at least 100 times, smaller than individual areas of protuberances 420 at the first elevation.

The present invention contemplates the use of a variety of fibers, such as, for example, papermaking cellulosic fibers, synthetic fibers, starch fibers, or any other suitable fibers, and any combination thereof. Papermaking fibers useful in the present invention include cellulosic fibers commonly known as wood pulp fibers. Fibers derived from soft woods (gymnosperms or coniferous trees) and hard woods (angiosperms or deciduous trees) are contemplated for use in this invention. The particular species of tree from which the fibers are derived is immaterial. The hardwood and softwood fibers can be blended, or alternatively, can be deposited in layers to provide a stratified web. U.S. Pat. No. 4,300,981 issued Nov. 17, 1981 to Carstens and U.S. Pat. No. 3,994,771 issued Nov. 30, 1976 to Morgan et al. are incorporated herein by reference for the purpose of disclosing layering of hardwood and softwood fibers.

The wood pulp fibers can be produced from the native wood by any convenient pulping process. Chemical processes such as sulfite, sulfate (including the Kraft) and soda processes are suitable. Mechanical processes such as thermomechanical (or Asplund) processes are also suitable. In addition, the various semi-chemical and chemi-mechanical processes can be used. Bleached as well as unbleached fibers are contemplated for use. When the fibrous web of this invention is intended for use in absorbent products such as paper towels, bleached northern softwood Kraft pulp fibers may be used. Wood pulps useful herein include chemical pulps such as Kraft, sulfite and sulfate pulps as well as mechanical pulps including for example, ground wood, thermomechanical pulps and Chemi-ThermoMechanical Pulp (CTMP). Pulps derived from both deciduous and coniferous trees can be used.

In addition to the various wood pulp fibers, other cellulosic fibers such as cotton linters, rayon, and bagasse can be used in this invention. Synthetic fibers, such as polymeric fibers, can also be used. Elastomeric polymers, polypropylene, polyethylene, polyester, polyolefin, and nylon, can be used. The polymeric fibers can be produced by spunbond processes, meltblown processes, and other suitable methods known in the art.

The paper furnish can comprise a variety of additives, including but not limited to fiber binder materials, such as wet strength binder materials, and dry strength binder materials. Suitable wet strength binders include, but are not limited to materials such as polyamide-epichlorohydrin resins sold under the trade name of KYMENE™ 557H by Hercules Inc., Wilmington, Del. Other wet strength binders include: Kymene G3 by Hercules Inc., Wilmington, Del., Cecamide 4949TB by Ceca, and Kenores 1440 by Eka Chemicals. Suitable temporary wet strength binders include but are not limited to synthetic polyacrylates. A suitable temporary wet strength binder is PAREZ™ 750 marketed by American Cyanamid of Stanford, Conn. Suitable dry strength binders include materials such as carboxymethyl cellulose and cationic polymers such as ACCO™ 711. The CYPRO/ACCO family of dry strength materials are available from CYTEC of Kalamazoo, Mich.

The embryonic web can be typically prepared from an aqueous dispersion of papermaking fibers, though dispersions in liquids other than water can be used. The fibers are dispersed in the carrier liquid to have a consistency of from about 0.1 to about 0.3 percent. Alternatively, and without being limited by theory, we believe that the present invention is applicable to moist forming operations where the fibers are dispersed in a carrier liquid to have a consistency less than about 50 percent. In yet another alternative embodiment, and still without being limited by theory, we believe that the present invention can also be applicable to air-laid structures (not shown), including air-laid webs comprising pulp fibers, synthetic fibers, and mixtures thereof.

When the plurality of fibers is deposited to the forming member 400, the protuberances therein form apertures in the embryonic web. Then, the embryonic web is transferred to the pressing section, i.e., to the fluid-permeable molding member 300, FIG. 13. The patterned framework 320 can be made from a variety of materials, including but not limited to: resinous material, metal, metal-impregnated resin, plastic, or any combination thereof.

If the framework 320 of the molding member 300 is made of the resinous material or other material having insufficient inherent strength, or has a pattern that can be distorted when pulled in the machine direction, a second reinforcing element 310 is typically used to enforce the framework 320. Then, the patterned framework 320 can be joined to the second reinforcing element 310. The reinforcing element may be necessary when the patterned framework 320 comprises a semi-continuous pattern or a pattern comprising a plurality of discrete protuberances. Typically, the reinforcing element 310 is positioned between the web-side 320a and at least a portion of the backside 320b of the framework 320. In some embodiments, the reinforcing element 310 may comprise the backside 320b of the framework 320.

The reinforcing element 310, 410 is fluid-permeable and can comprise a woven screen, or an apertured element, a felt, or any combination thereof. Various types of the fluid-permeable reinforcing element are described in several commonly assigned US patents, for example, U.S. Pat. Nos. 5,275,700 and 5,954,097, the disclosures of which are incorporated herein by reference. The reinforcing element 310 may comprise a felt, also referred to as a “press felt” as is used in conventional papermaking. The framework 320 may be applied to the reinforcing element 310 as taught by commonly assigned U.S. Pat. Nos. 5,549,790, issued Aug. 27, 1996 to Phan; 5,556,509, issued Sep. 17, 1996 to Trokhan et al.; 5,580,423, issued Dec. 3, 1996 to Ampulski et al.; 5,609,725, issued Mar. 11, 1997 to Phan; 5,629,052 issued May 13, 1997 to Trokhan et al.; 5,637,194, issued Jun. 10, 1997 to Ampulski et al.; 5,674,663, issued Oct. 7, 1997 to McFarland et al.; 5,693,187 issued Dec. 2, 1997 to Ampulski et al.; 5,709,775 issued Jan. 20, 1998 to Trokhan et al., 5,795,440 issued Aug. 18, 1998 to Ampulski et al., 5,814,190 issued Sep. 29, 1998 to Phan; 5,817,377 issued Oct. 6, 1998 to Trokhan et al.; and 5,846,379 issued Dec. 8, 1998 to Ampulski et al., the disclosures of which are incorporated herein by reference.

If desired, the reinforcing element comprising a Jacquard-weave structure can be utilized. Illustrative belts comprising the Jacquard-weave structure can be found in U.S. Pat. Nos. 5,429,686 issued Jul. 4, 1995 to Chiu, et al.; 5,672,248 issued Sep. 30, 1997 to Wendt, et al.; 5,746,887 issued May 5, 1998 to Wendt, et al.; and 6,017,417 issued Jan. 25, 2000 to Wendt, et al., the disclosures of which are incorporated herein by reference for the limited purpose of showing a principal construction of the Jacquard weave that can be used in the reinforcing element.

The patterned framework 320 can be substantially continuous, substantially semi-continuous, comprise a plurality of discrete protuberances, or any combination thereof. The substantially continuous framework 320 is best shown in FIGS. 10 and 11. The semi-continuous framework 320 is not shown in the figures per se, but could be easily visualized by one skilled in the art from FIG. 6 showing a fragment of the fibrous structure 100 made on the molding member 300 having a semi-continuous framework.

Most typically, the framework 320 is made of a curable resinous material, by selectively (through a mask having a pattern of opaque regions and transparent regions) curing a coating of the resinous material. Several incorporated by reference and commonly assigned US patents referred to above describe processes that can be used to make the molding member 300. Suitable curable resinous materials can be readily selected from the many those commercially available. For example, the curable material may comprise liquid photosensitive resins, such as polymers that can be cured or cross-linked under the influence of a suitable radiation, typically an ultraviolet (UV) light. References containing more information about liquid photosensitive resins include Green et al., “Photocross-linkable Resin Systems,” J. Macro-Sci. Revs. Macro Chem., C21 (2), 187-273 (1981-82); Bayer, “A Review of Ultraviolet Curing Technology,” Tappi Paper Synthetics Conf. Proc., Sep. 25-27, 1978, pp. 167-172; and Schmidle, “Ultraviolet Curable Flexible Coatings,” J. of Coated Fabrics, 8, 10-20 (July, 1978). All the preceding three references are incorporated herein by reference. Example of the suitable liquid photosensitive resins are included in the Merigraph series of resins made by MacDermid GRAPHICARTS, Incorporated, of Wilmington, Del.

Commonly assigned patent application Ser. No. 09/346,061, titled “Papermaking Belts Having Patterned Framework With Synclines Therein And Paper Made Therewith,” filed in the name of Trokhan, is incorporated herein by reference. This application discloses a framework that is interrupted (on its web-side) and subdivided by synclines. The framework, synclines, and deflection conduits, respectively, impart first, second, and third values of intensive properties to regions of a paper made on these portions of the belt. The value of the intensive property of the regions of the paper corresponding to the synclines is intermediate to those of the paper regions corresponding to the framework and the deflection conduits. For example, if the belt is used as the molding member 300, the density of the fibrous structure regions corresponding to the synclines can be less than the density of the fibrous structure regions corresponding to the framework but greater than the density of the fibrous structure regions corresponding to the deflection conduits; and if the belt is used as the forming member, the basis weight of the fibrous structure regions corresponding to the synclines may be greater than the density of the fibrous structure regions corresponding to the framework but less than the basis weight of the fibrous structure regions corresponding to the deflection conduits.

Conventional papermaking equipment and processes can be used to form the embryonic web on the forming member 400. The association of the embryonic web with the molding member 300 can be accomplished by simple transfer of the web between two moving endless belts and assisted by differential fluid pressure, FIG. 13. The fibers may be deflected into the deflection conduits of the molding member 300 by the application of differential fluid pressure induced by an applied vacuum (for example, by a vacuum apparatus 350). Any technique, such as the use of a Yankee drum dryer 370, can be used to dry the web.

The plurality of fibers can also be supplied in the form of a moistened fibrous web (not shown), which should preferably be in a condition in which portions of the web could be effectively deflected into the deflection conduits of the molding member and the void spaces formed between the suspended portions and the X-Y plane.

In FIG. 13, the embryonic web is transferred from the forming member 400 to the molding member 300 by a vacuum pick-up shoe 390. Alternatively or additionally, a plurality of fibers, or fibrous slurry, can be deposited to the molding member 300 directly (not shown) from a headbox 480 or otherwise. In a continuous process, the forming member 400, in the form of an endless belt, travels (in a direction A) around rolls 400a, 400b, and 400c, and the molding member 300, also in the form of an endless belt, travels about rolls 300a, 300b, 300c, and 300d (in a direction B).

The step of deflecting a first plurality of selected portions of fibers into the first plurality of deflection conduits 330 of the molding member 300 produces a plurality of fibrous pillows in the web. Depending on the process, simultaneously with or immediately before or after deflection of the first plurality of selected portions of fibers into the first plurality of deflection conduits 330, a second plurality of selected portions of fibers can be deflected into the second plurality of deflection conduits 340 of the molding member 300—to form a plurality of pseudo-apertures 200. Depending on the process, mechanical, as well as fluid pressure differential, either alone or in combination with one another, can be utilized to deflect portions of the fibers into the deflection conduits of the molding member 300. For example, in a through-air drying process shown in FIG. 13, a vacuum apparatus 350 applies a fluid pressure differential to the web disposed on the molding member 300, thereby deflecting fibers into the deflection conduits of the molding member 300. The process of deflecting the fibers into the deflection conduits 330 and/or 340 may be continued or repeated as another vacuum apparatus 360 applies an additional vacuum pressure to the web to even further deflect the fibers into the deflection conduits of the molding member 300.

If desired, the step of deflecting the fibers into the deflection conduits of the molding member 300 can be accomplished by using a process disclosed in commonly assigned U.S. Pat. No. 5,893,965, issued in the name of Trokhan et al. on Apr. 13, 1999, the disclosure of which is incorporated herein by reference. According to that process, a web disposed on the molding member 300 is overlaid with a flexible sheet of material 500 such that the web is disposed intermediate the sheet of material 500 and the molding member 300, as schematically shown in FIG. 13. The flexible sheet of material 500 has an air-permeability less than that of the molding member 300, and can be completely air-impermeable. An application of a fluid pressure differential (from the vacuum apparatus 360) to the flexible sheet of material 500 causes deflection of at least a portion of the flexible sheet of material 500 towards the molding member 300, and under a very high pressure into the deflection conduits of the molding member 300, which facilitates deflection of at least a portion of the fibers into the deflection conduits of the molding member 300. In the present invention, the sheet of material 500 can have orifices therethrough (not shown) corresponding to a desired pattern of the pseudo-apertures 200. In a continuous process of FIG. 13, the flexible sheet of material travels around rolls 500a, 500c, and 500c in a direction C.

The process may further comprise a step of impressing the web against a pressing surface, such as, for example, a surface of a Yankee drying drum 370, thereby densifying portions of the web. In FIG. 13, the step of impressing the web against the Yankee drying drum 370 is performed by using a pressure roll 300c. This also typically includes a step of drying the web.

Finally, the web associated with the molding member 300 can be separated from the molding member 300, to form the pseudo-apertured fibrous structure 100 of the present invention.

The process of making the pseudo-apertured fibrous structure 100 can also include a step of foreshortening comprising creping, wet-microcontraction, or any combination thereof. As used herein, foreshortening refers to reduction in length of a dry paper web, resulting from application of energy to the web. Foreshortening by creping can be accomplished by any conventional technique, for example, with the use of a creping blade 380 shown in FIG. 13. Creping is disclosed in commonly-assigned U.S. Pat. No. 4,919,756, issued Apr. 24, 1992 to Sawdai, the disclosure of which is incorporated herein by reference. Alternatively or additionally, foreshortening may be-accomplished via wet-microcontraction, as taught in commonly-assigned U.S. Pat. No. 4,440,597, issued Apr. 3, 1984 to Wells et al., the disclosure of which incorporated herein by reference.

What is claimed is:

1. A multi-ply filter comprising at least two adjacent plies, wherein at least one of the plies comprises a multi-density fibrous structure having a plurality of discrete pseudo-apertures disposed therein, the pseudo-apertures having individual areas of at least about 3 square millimeters and a basis weight from about 0.1 to about 5 gram per square meter.

2. The filter of claim 1, wherein the at least one of the plies has from about 5,000 to about 90,000 pseudo-apertures per square meter.

3. The filter of claim 2, wherein the individual areas of the pseudo-apertures have a major axis and a minor axis perpendicular to the major axis, and wherein the major axis is from about 1 times to about 100 times greater than the minor axis.

4. The filter of claim 1, wherein one of the at least two plies comprises a substantially continuous network region and a plurality of fibrous pillows outwardly extending from the network region, and wherein a density of the network region is greater than a density of the fibrous pillows.

5. A multi-ply filter comprising:
(a) a bottom ply comprising a substantially continuous network region and a plurality of fibrous pillows outwardly extending from the network region, wherein a density of the network region is greater than a density of the fibrous pillows; and
(b) a plurality of mutually adjacent pseudo-apertured plies comprising at least a first pseudo-apertured ply and a second pseudo-apertured ply, wherein each of the pseudo-apertured plies comprises a fibrous structure having a plurality of discrete pseudo-apertures disposed therein, wherein the pseudo-apertures have individual areas of at least about 3 square millimeters; and
wherein the individual areas of the pseudo-apertures are at least 10 times larger than individual areas of the fibrous pillows of the bottom ply.

6. The filter of claim 5, wherein the plurality of mutually adjacent pseudo-apertured plies comprises three plies.

7. The filter of claim 5, wherein the pseudo-apertures of at least the first ply are offset relative to the pseudo-apertures of at least the second ply.

8. The filter of claim 7, wherein at least one of the pseudo-apertured plies comprises a fibrous structure having relatively high-density regions, relatively low-density regions, and intermediate-density regions.

9. The filter of claim 8, wherein the relatively low-density regions comprise the plurality of discrete pseudo-apertures.

10. The filter of claim 9, wherein the relatively high-density regions comprise a substantially continuous network region, and the intermediate-density regions comprise a plurality of discrete fibrous pillows extending outwardly from the network region.

11. The filter of claim 11, wherein the pseudo-apertured plies are disposed such that the plurality of fibrous pillows of at least one of the pseudo-apertured plies faces the bottom ply.

12. The filter of claim 10, wherein the individual areas of the pseudo-apertures are at least 10 times larger than the individual areas of the discrete fibrous pillows of the pseudo-apertured plies.

13. The filter of claim 5, wherein the at least one of the pseudo-apertured plies is foreshortened.

14. The filter of claim 5, wherein the individual areas of the pseudo-apertures in the pseudo-apertured plies consecutively increase from a pseudo-apertured ply adjacent to the bottom ply to a pseudo-apertured ply farthest from the bottom ply.

15. A process for making a multi-ply filter, the process comprising the steps of:
(a) providing a bottom ply comprising a substantially continuous network region, and a plurality of fibrous pillows outwardly extending from the network region, wherein a density of the substantially continuous network region is greater than a density of the fibrous pillows;
(b) providing a plurality of pseudo-apertured plies, wherein each of the pseudo-apertured plies comprises a fibrous structure having a plurality of discrete pseudo-apertures disposed therein, wherein the pseudo-apertures have individual areas of at least about 3 square millimeters and a basis weight from about 0.1 to about 5 gram per square meter;
(c) superimposing the bottom ply with the plurality of pseudo-apertured pies such that the pseudo-apertured plies are consecutively disposed in a contacting face-to-face relationship to one another, whereby the multi-ply filter is formed.

16. A water-purification kit, comprising:
(a) a multi-ply filter comprising at least two adjacent plies, wherein at least one of the plies comprises a differential-density fibrous structure having a plurality of discrete pseudo-apertures disposed therein, wherein the pseudo-apertures have individual areas of at least about 3 square millimeters; and
(b) a water-purification composition comprising a flocculation agent and a coagulation agent.

17. The water-purification kit of claim 16, wherein the water-purification composition comprises:
(i) a primary coagulant selected from the group consisting of water-soluble, multivalent inorganic salts and mixtures thereof;
(ii) a bridging flocculant selected from the group consisting of water-soluble and water-dispersible anionic and nonionic polymers having a weight average molecular weight of at least about 2,000,000, and mixtures thereof; and
(iii) a coagulant aid selected from the group consisting of water-soluble and water-dispersible cationic polymers having a weight average molecular weight of less than about 1,500,000, and mixtures thereof.

18. The water-purification kit of claim 16, wherein the water-purification composition further comprises a disinfectant.

19. A process for obtaining a purified water, the process comprising the steps of:
(a) providing a multi-ply filter comprising at least two adjacent plies, wherein at least one of the plies comprises a fibrous structure having a plurality of discrete pseudo-apertures disposed therein, the pseudo-apertures having individual areas of at least about 3 square millimeters and a basis weight from about 0.1 to about 5 gram per square meter;
(b) providing a water-purification composition comprising a flocculation agent and a coagulation agent;
(c) instructing a user to
(i) contact an unpurified water with the water-purification composition, thereby obtaining a partially purified water containing solid matter, and
(ii) pour the partially purified water through the multi-ply filter to at least partially remove the solid matter, whereby obtaining the purified water.

20. A process for obtaining a purified water having a turbidity of less than 2 nephelometric turbidity units from an unpurified water having a turbidity of greater than 2 nephelometric turbidity units, the process comprising the steps of:
(a) providing a multi-ply filter having an effective surface area from 0.1 to about 1 square meters and comprising at least three adjacent plies, wherein each of at least two of mutually-adjacent plies comprises a fibrous structure having a plurality of discrete pseudo-apertures disposed therein, the pseudo-apertures having individual areas of at least about 3 square millimeters to about 15 square millimeters;
(b) providing a water-purification composition comprising a flocculation agent and a coagulation agent;
thereby enabling a user to
(i) mix an unpurified water with the water-purification composition to obtain a partially purified water comprising solid matter, and
(ii) pour the partially purified water through the filter at a flow filtration rate of greater than about 2 liters per minute, to at least partially remove the solid matter, whereby obtaining the purified water having a turbidity of less than 2 nephelometric turbidity units.
